(19) United States
(12) Patent Application Publication
(10) Pub. No.: US 2007/0067218 A1
(43) Pub. Date: Mar. 22, 2007

(54) Web based promotion of drug products driven by price point and performance rebates

(75) Inventor: Brian Bingham, Layton, UT (US)

Correspondence Address: GIBBONS, DEL DEO, DOLAN, GRIFFINGER & VECCHIONE, 1 RIVERFRONT PLAZA, NEWARK, NJ, 07102-5497, US

(73) Assignee: Design Rx, Inc.

(21) Appl. No.: 11/522,658

(22) Filed: Sep. 18, 2006

Related U.S. Application Data
(60) Provisional application No. 60/718,525, filed on Sep. 19, 2005.

(51) Int. Cl. G06Q 30/00; G06Q 10/00

(52) U.S. Cl. 705/14; 705/2

(57) ABSTRACT

A system and method in accordance with the principles of the invention provides a Web based drug product promotion which uses an administrator's webpage to list a network of participating pharmacies and promotes lower pricing of drug products by its network than that offered by other pharmacies. This is accomplished by first securing rebate commitments from drug suppliers of the drug products for reaching specific amounts of purchases of the drug products by the network. This is combined with securing pricing, performance and promotional commitments from the participating pharmacies in the network with respect to such drug products, such that the pricing and performance reflects rebates assigned to the participating pharmacies for reaching certain levels of market share at specified price points.

### CROSS REFERENCE TO RELATED APPLICATION:

This application claims priority from provisional U.S. Application Serial No. 60/718,525, filed Sep. 19, 2005, incorporated herein by reference in its entirety.

### FIELD OF THE INVENTION

The invention is related generally to health benefits and more specifically to a system and method for using the Web to promote drug pricing offered by a network of pharmacies driven by using a price point and performance based rebate structure.

### BACKGROUND OF THE INVENTION

Drug suppliers offer rebates for drug purchases when purchasers meet certain target quantity purchase levels. These rebates are offered using multiple approaches. In the first approach, the drug suppliers use a sliding scale that is based on the market share gained by the purchasers. This is used to establish the rebate amount given to the purchasers. The larger the market share represented by the purchasers, the greater the rebate. In another approach, the drug suppliers use a tiered approach such that once the amount of purchases has reached a tiered level, it triggers a jump in the rebate percentage offered to the purchasers.

Traditionally, pharmacy benefit managers (PBMs) and managed care organizations (MCOs) negotiate with such drug suppliers on behalf of their clients for rebates by relying upon the historical overall drug utilization pattern for particular drugs by their clients in total. The clients may or may not be dispensed a roll back rebate from the PBM or MCO based on the client's actual drug utilization pattern. The difference in the rebate received by the PBM or MCO over the roll back rebate is kept by the PBM or MCO. Such a difference is used to help cover administrative costs of the PBM or MCO. The clients may be employer/plan sponsors of managed care, for example. This concept is generally known and discussed in the Pharmacy Benefit Insider in an article entitled “Uncovering the Mysteries Behind Drug Rebates”, June 2002, Drug Cost Management Report by Chris Nee.

Thus, where clients have sufficient power, they can take advantage of lower prices for drug supplies through roll back rebates from purchases of such drug supplies by their members. However, individuals desiring to purchase drug supplies other than through an employer/plan sponsor are unlikely to make sufficient purchases for themselves to qualify for supplier market share rebates. On the other hand, pharmacies handle the purchases of such individuals. When such purchases are combined with those by individuals purchasing drug supplies at other pharmacies, the overall purchases may be sufficient to attain sufficient market share to take advantage of drug supplier rebates.

### BRIEF SUMMARY OF THE INVENTION

A system and method in accordance with the principles of the invention provides a Web based drug product promotion which uses an administrator's webpage to list a network of participating pharmacies and promotes lower pricing of drug products by its network than that offered by other pharmacies. This is accomplished by first securing rebate commitments from drug suppliers of the drug products for reaching specific amounts of purchases of the drug products by the network. This is combined with securing pricing, performance and promotional commitments from the participating pharmacies in the network with respect to such drug products, such that the pricing and performance reflects rebates assigned to the participating pharmacies for reaching certain levels of market share at specified price points.

In accordance with one aspect of the inventive method, the amount of the rebate to the participating pharmacies is a function of both the market share enjoyed by the network of participating pharmacies, i.e., performance, and the price point at which the drug products are sold to the end users of the drug products. As the market share price reaches a particular level corresponding to a market share tier of a tiered market share structure, the rebate percentage may jump to a higher level. In addition, the amount of the rebate increases as the actual selling price of the drug products decrease.

In accordance with another aspect of the invention, by forming a network of pharmacies, an administrator of the network is in a position to contract with drug suppliers and the pharmacies to secure rebates from the drug suppliers based upon the combined purchasing power of the pharmacies for specific drugs offered by the drug suppliers and to provide roll back rebates to the individual pharmacies in the network based on their selling efforts. Thus, there is an incentive for the pharmacies to promote such specific drugs by offering the drugs at a lower cost that reflects the anticipated rebate. Such pharmacies in the network can offer a lower cost for such drug supplies than can other pharmacies whose pricing does not reflect the roll back rebate. In addition, the participating pharmacies may provide their own website with a link to the administrator's webpage to assist in the promotion of the drug products.

In yet another aspect of the invention, the pharmacies and the administrator help drive sales for specific drugs by advertising to customers or referrals of customers by emphasizing the lower prices available through the Web and specifically the administrator's website and the participating pharmacies' websites. Thus, the administrator may run a website that identifies the pharmacies within the network and that promotes the lower prices offered by its network of pharmacies for drug supplies, whether they are drug supplies that are generally not covered by managed care programs at all or only to a limited extent. In the latter case, the typical purchaser will pay the full purchase price as opposed to just making a co-payment through a managed care, drug payment plan or the like. By making a purchase at a participating member of the network, such purchasers benefit from the lower pricing offered by the participating pharmacies that reflects the rollback rebate due the pharmacy.

In accordance with the inventive method, the administrator of the network may be paid from the difference in the overall rebate percentage rebate and the roll back rebate. The amount of the rebate may be negotiated between the administrator and the pharmacies in the network. The amount of the rebate due participating pharmacies will be higher in comparison to each pharmacy negotiating a rebate based on its individual market share. The overall market share attributed to the entire network of pharmacies will entitle participating pharmacies to larger rebate percentages from the drug suppliers.

### BRIEF DESCRIPTION OF THE DRAWINGS:

In the drawings:

FIG. 1 illustrates a top-level system according to the principles of the invention;

FIG. 2 illustrates an administrator's website according to the principles of the invention; and

FIG. 3 illustrates a Pharmacy's webpage on an administrator's website according to the principles of the invention.

### DETAILED DESCRIPTION OF THE INVENTION

I. Overview

In general, the inventive system and method uses the Web to promote drug product pricing offered by a network of pharmacies driven by using a price point and performance based rebate structure.

For purposes of clarity, an exemplary architecture and method are first described, followed by a discussion of the rebate structure employed in association with the architecture and method.

II. Exemplary Embodiment

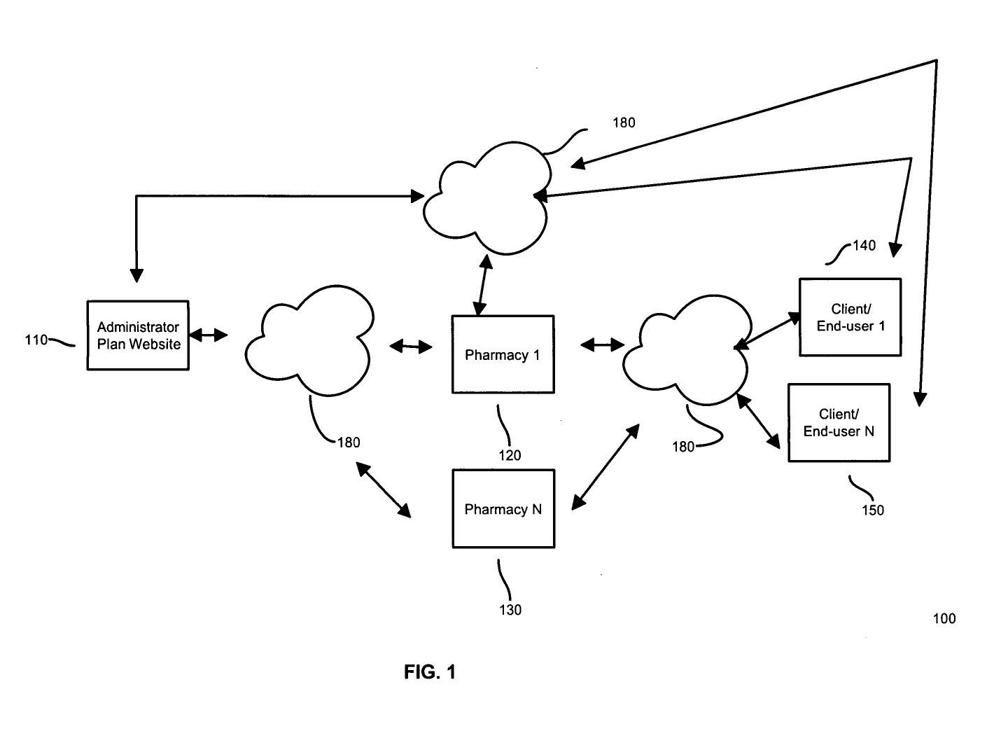

Referring to FIG. 1, there is shown a top-level architecture for a system 100 that implements the plan in accordance with the principles of the invention. System 100 has a plan administrator website 110 operably connected to a plurality of pharmacies or equivalent drug product outlets 120 through 130 via a communication network 180, such as for example, the Internet. Clients/end-users 140 through 150 engage system 100 by operably connecting to plurality of pharmacies or equivalent drug product outlets 120 through 130 directly or indirectly through plan administrator website 110, which has an interactive link to the plurality of pharmacies or equivalent drug product outlets 120 through 130.

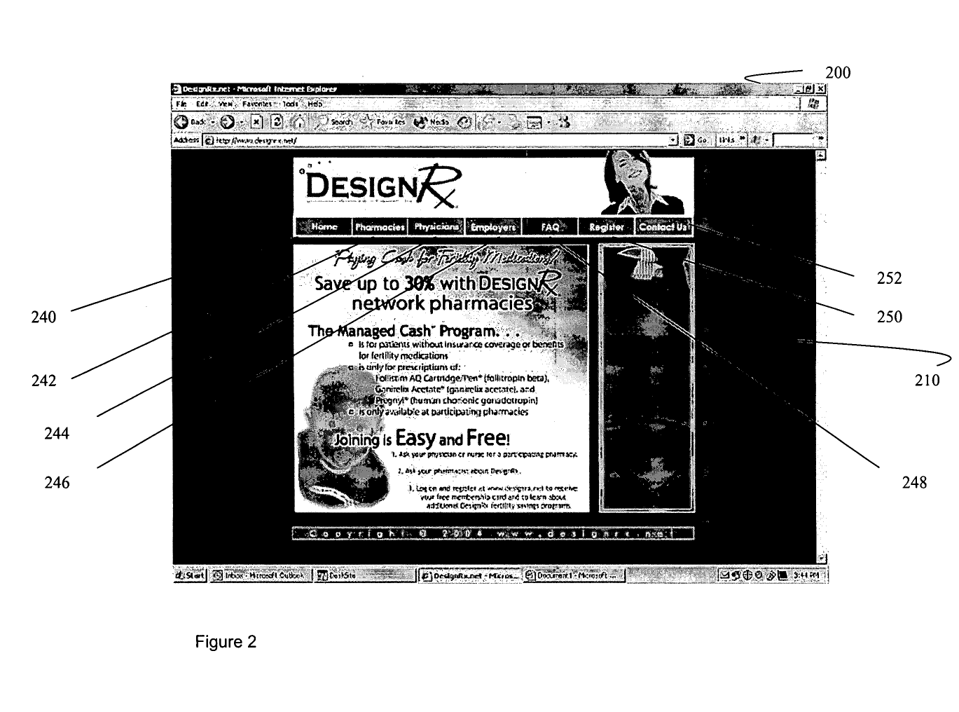

Referring now to FIG. 2, there is shown a plan administrator website 200 in accordance with the principles of the invention. Plan administrator website 200 has a promotion page 210 for illustrating the benefits of the inventive system and which drug products are available in the plan. Plan administrator website 200 further includes a plurality of hyperlinks to additional webpages including for example, Home 240, Pharmacies 242, Physicians 244, Employers 246, FAQ 248, Register 250, and Contact Us 252.

Clients/end-users 140 through 150 use, for example, the Register 250 webpage to enroll in the plan to take advantage of the lower pricing offered by the participating pharmacies. Enrolled members will receive an identification card so that they can visit any participating pharmacy to take advantage of the lower costs for certain drug products. Certain eligibility requirements may need to be met by members to benefit from the plan. For example, the plan may only provide a benefit to those members who do not have access to any third party coverage for drug products, or to those whose third party coverage for drug products has expired. Moreover, members who have third party coverage for any portion of their prescription for a drug product are not eligible for the plan with respect to that drug product.

From the Contact Us webpage 252, the plan administrator may also provide contact information so that potential clients/end-users can enroll telephonically using a telephone communication center staffed to enroll patients into the plan. The plan administrator will make available to potential members a toll free telephone number to be answered. The plan administrator employees will be trained to answer member inquiries about participation in the plan.

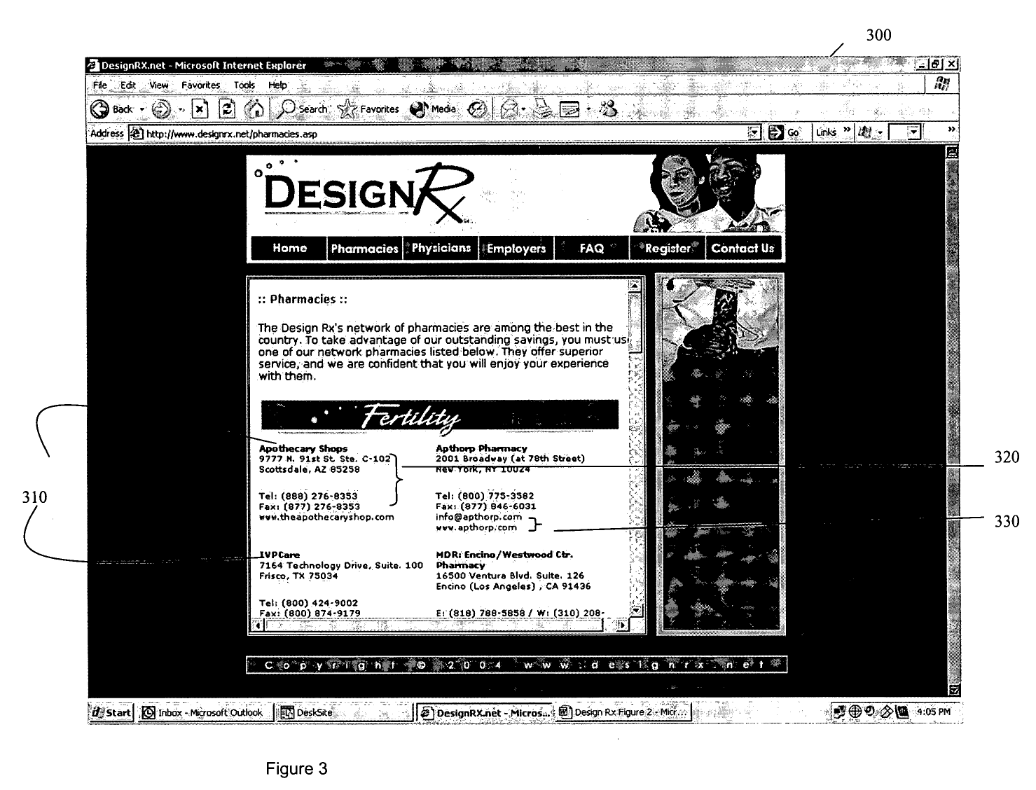

Referring now to FIG. 3, a Pharmacy's webpage 300 includes a list of pharmacies 310 that are participating in system 100 to deliver better prices to clients/endusers 140-150. Specifically, for each participating pharmacy, contact information 320 is provided, including links 330 to go to the participating pharmacy website.

II. Rebate Structure

To obtain the benefits described above from the inventive system, the administrator has to put into operation two rebate structures. The first rebate structure discussed below operates between the administrator and the drug product supplier. The second rebate structure discussed below operates between the administrator and pharmacies that desire to participate in the system. The combination of the two rebate structures and their corresponding requirements, as detailed below, results in lower prices to clients/end-users, and rebates to participating pharmacies and to the administrator, respectively. Although presented as the first and second rebate structures, either rate structure can be established first followed by the second or they can be established simultaneously.

a. Administrator and Drug Product Supplier

As stated above, the first rate structure that can be established is between the drug product supplier and the plan administrator. Specifically, the drug product supplier discounts the price of its drug products by paying the plan administrator rebates with respect to drug products dispensed to members of the plan. Certain exemplary terms and conditions are reviewed below.

Specifically, the rebate amount per drug product shall be equal to the Wholesale Acquisition Cost (WAC) of the current month multiplied by the percentage rebate offered on the drug product, as shown below. The rebate amount can be calculated on the basis of a single unit of a drug product as shown below, e.g., capsule, milligram, milliliter or tablet dosage form, and the total number of units dispensed or by using any other counting measure. However, no rebate amount may be payable with respect to the drug products dispensed to any member of the plan which was subject to a discount or other payment from the drug product supplier pursuant to another plan which the benefiting member may have with the drug product supplier.

An exemplary rebate structure between the drug product supplier and the plan administrator is described below. The examples shown here and in the provisional application are hypothetical and illustrative in nature. These examples, particularly those in the provisional application, were intended to serve as a “place-holder” reference only and do not reflect actual contract or financial terms used in commerce. For example, the inventive method and system can be used for any drug products and the threshold and rebate values vary depending on the specific drug product. In particular, the threshold and rebate values are dependent on a number of variables including cost, number of pharmacies in network, administrative costs etc.

First Exemplary Rate Structure:

The following percent rebates could offered to a plan administrator for utilization by all participating pharmacies provided the drug products listed are exclusive drug products as listed in the plan administrator's formulary as shown below:

| Product | Unit Size | Rebate |
|---|---|---|
| Drug Product A | sss IU | See Table 1 |
| | xxx IU | See Table 1 |
| Drug Product B | yyy IU | X % |
| Drug Product C | zzz ug | Follows qualifying |
| | | Drug Product A |
| | | Rebate |

TABLE 1

| Drug Product A Market Share* | Rebate % |
|---|---|
| ≧A % | D % |
| ≧B %-<A % | E % |
| ≧C %-<B % | F % |
| <C % | G % |

Second Exemplary Rate Structure:

The following percent rebates could offered to a plan administrator for utilization by all participating pharmacies provided the drug products listed are exclusive drugs as listed in the plan administrator's formulary as shown below:

| Product | Unit Size | Rebate |
|---|---|---|
| Drug Product A | P IU | See Table 2 |
| | Q IU | See Table 2 |
| Drug Product B | R IU | L % |
| Drug Product C | S ug | Follows qualifying |
| | | Drug Product A |
| | | Rebate |

TABLE 2

| Drug Product A Market Share* | Rebate % |
|---|---|
| ≧M % | T % |
| ≧N %-<M % | U % |
| ≧P %-<N % | V % |
| <P % | W % |

For the exemplary rebate structures shown above, the market basket includes: Drug Product A (all presentations), Drug Product B (all presentations) and Drug Product C (all presentations) dispensed to members who do not have access to any third party coverage for products or whose third party coverage for products being dispensed has expired. Market share will be calculated on a monthly basis. The rebates may be paid on individual participating pharmacy performance or an aggregate performance of all participating pharmacies. The plan administrator will select the rebate option.

In order to receive payments, the plan administrator may be required to submit a report to the drug product supplier that may include the following data:
1. Summary by drug product, of total units dispensed to members, including competitive products within each class.
2. Report by participating pharmacy of each drug product dispensed to members, in an NCPDP flat file format. Report may include:
   a. Participating pharmacy name, address, NCPDP number and Plan Type
   b. Product name
   c. NDC number
   d. Date dispensed
   e. Rx number and Rx refill number
   f. Rx fill date
   g. The amount the member paid to the participating pharmacy at the point of sale
   h. Participating plan ID number (Tax ID or HIN), as it appears on supporting detail data, where relevant.
   i. Unit quantity (metric decimal quantity dispensed)
   j. Prescribing physician's DEA#

In addition to the above rate structure, rebates may not be paid on the following situations/products:
1. Claims submitted with an inactive NCPDP number.
2. Claims submitted with a non-standard, truncated or encrypted Prescription numbers.
3. Duplicated claims submitted (i.e., same fill date, Rx number or NCPDP number).
4. Claims submitted with a unit quantity in excess of a four (4) month supply of the drug product.
5. Claims submitted from Participating Pharmacies located in Puerto Rico.
6. Claims filed more than ninety (90) days prior to the beginning of the current month. (Current defined as the month for which Customer is submitting a rebate invoice).
7. Claims submitted for Members who are covered under Medicare or Medicaid supplemental program.
   b. Administrator and Pharmacy

As stated above, a second rate structure must also be established so that there is an incentive for the pharmacies to promote such specific drug products by offering the drug products at a lower cost that reflects an anticipated rebate. Such pharmacies in the network can offer a lower cost for such drug product supplies than other pharmacies whose pricing does not reflect the rebate. Certain exemplary terms and conditions are reviewed below.

Specifically, the participating pharmacy shall not participate in any other plan with any other drug product supplier that competes directly or indirectly, with the specified drug products.

An exemplary rebate structure between the pharmacy and the plan administrator is shown below using exemplary drug products. Any drug product can be used with appropriate rebate percentages. Specifically, for the purposes of market share calculations the market basket is Drug Product A (all presentations), and Drug Product B (all presentations). All presentations and NDCs for these apply. Units dispensed will be based on X IU increments. A unit that is dispensed as part of a prescription that is covered in whole, or in part, by a third party entity (HMO/PBM/manufacturer patient assistance program, etc) shall not be counted in the market share basket.

DesignRx 1

| Drug Product A Market Share* | Rebate % |
|---|---|
| Tier I: ≧W % | WAC - Z % |
| Tier II: ≧X %-<W % | Δ between actual selling price and |
| | (WAC less T %) |
| Tier III: >Y %-<X % | Δ between actual selling price and |
| | (WAC less than U %) |
| Tier IV: ≦Y % | R % |

*Rebates will be paid on the difference between actual selling price up to WAC less Z % and the qualifying rebate tier.

### EXAMPLE 1

| | |
|---|---|
| Pharmacy's actual sale price: | $aaa |
| Pharmacy's market share: | X + 1% |
| Qualifying Rebate Tier: | Tier 2 |

(WAC less T %)−(actual selling price)=Rebate dollars
WAC less T %=$yyy
Rebate=$yyy−$aaa=$nnn
Qualifying rebate tiers:
Tier I

If market share for Drug Product A is greater than or equal to W % for the rebate period, then the plan administrator will rebate the difference between the actual selling price per unit and WAC up to an actual selling price of Z % off of the published WAC.

Tier II

If market share for Drug Product A is less than W % and greater than or equal to X % for the rebate period then the plan administrator will rebate the difference between the actual selling price per unit and WAC minus Z % up to an actual selling price of Z % off of the published WAC.

Tier III

If market share for Drug Product A is less than X % and greater than or equal to Y % for the rebate period, then the plan administrator will rebate the difference between the actual selling price per unit and WAC minus U % up to an actual selling price of Z % off of the published WAC.

Tier IV

If market share for Drug Product A is less than Y % for the rebate period, then no rebate will be paid.

Drug Product B rebates will be based on Drug Product B market share and will follow the qualifying rebate structure outlined for Drug Product A in Tiers l-IV.
Example: If Drug Product A qualifies for Tier II, then the same rebate calculations in Tier II will be used and will be based on the published WAC of Ganirelix to determine the rebate for Ganirelix.

Drug Product C rebate will be published WAC minus Z % for all utilization.

In order to receive payments, the plan administrator may be required to submit a report to the drug product supplier that may include the following data:
1) Summary by drug product of total units dispensed. Submission shall include all units dispensed within the class whether eligible for rebates under this program or not (i.e. those units/prescriptions covered in whole or part by a third party).
2) Summary by drug product of dollars reimbursed to participating pharmacies for each drug product dispensed to members.
3) Report by participating pharmacy of each drug product dispensed to members and contain the information below:
   (a) Participating pharmacy name, address, NCPDP number and plan type if applicable. No rebate will be paid for claim that is paid for in full or in part by a third party.
(b) Drug product name
(c) NDC number
(d) Date dispensed
(e) Rx number & Rx refill number
(f) Rx Fill date
(g) Actual selling price per unit
(h) The amount the member paid to the participating pharmacy at the point of sale.
(i) The amount paid to the participating pharmacy by a plan or any other funded source (if relevant).
(j) Participating Plan ID number (Tax ID or HIN), as it appears on supporting detail.
(k) Unit quantity (metric decimal quantity dispensed)
(l) Prescribing physician DEA number
(m) NABP number.

Plan administrator reserves the right to update this list at its sole discretion on a quarterly basis and may not pay rebates under the following situations/products:
1. Claims submitted with an inactive NCPDP number.
2. Claims submitted with a non-standard, truncated or encrypted Prescription numbers.
3. Duplicated claims submitted (i.e., same fill date, Rx number, or NCPDP number).
4. Claims submitted with a unit quantity in excess of a three (3) month supply of a drug product.
5. Claims filed more than ninety (90) days prior to the beginning of the current month.
6. Any other non-compliant claim, in whole or in part.
7. Any unit that is dispensed as part of a prescription that is covered in whole or in part, by a third party entity, including but not limited to indemnity coverage, HMO, PBM, manufacturer patient assistance program, or any other type of funded assistance to the patient.
8. Any unit dispensed that is determined to be purchased from an unauthorized source or from outside the United States.
   III. Effect of Plan

As illustrated above, the amount of the rebate to the participating pharmacies is a function of both the market share enjoyed by the network of participating pharmacies, i.e., performance, and the price point at which the drug products are sold to the end users of the drug products. As the market share price reaches a particular level corresponding to a market share tier of a tiered market share structure, the rebate percentage may jump to a higher level. In addition, the amount of the rebate increases as the actual selling price of the drug products decrease. Thus, there is an incentive for the pharmacies to promote such specific drugs by offering the drugs at a lower cost that reflects the anticipated rebate. Such pharmacies in the network can offer a lower cost for such drug supplies than can other pharmacies whose pricing does not reflect the roll back rebate.

The pharmacies and the administrator help drive sales for specific drugs by promoting using the Web and specifically the administrator's website and the participating pharmacies' websites. The administrator's website identifies the pharmacies within the network and promotes the lower prices offered by its network of pharmacies for drug supplies, whether they are drug supplies that are generally not covered by managed care programs at all or only to a limited extent.

While the foregoing description and drawings represent the preferred embodiments of the present invention, it will be understood that various changes and modifications may be made without departing from the scope of the present invention.

What is claimed is:

1. A method for promoting drug products using the Web, comprising the steps of:
securing a network of pharmacies that is driven to offer lower prices for drug products in response to receiving rebates that are based on reaching certain levels of market share at specified drug product prices;
securing drug product suppliers that will provide rebates in response to market share;
listing the network of pharmacies on an administrator's website; and
promoting on the administrator's website that the network of pharmacies offer lower pricing for drug products for members.

2. The method of claim 1, further comprising the step of registering potential members meeting eligibility requirements.

3. The method of claim 2, wherein a rebate structure for the network of pharmacies has built-in incentives to decrease the cost of drug products to members.

4. The method of claim 1, wherein links are provided on the administrator's website to the network of pharmacies.

5. The method of claim 1, wherein contact information is provided for the network of pharmacies.

6. The method of claim 2, wherein the eligibility requirements include potential members who do not have insurance coverage.

7. The method of claim 2, wherein the eligibility requirements include potential members who do not have drug product insurance coverage.

8. The method of claim 1, wherein increasing market share and decreasing drug product prices results in increased rebates to network of pharmacies.

9. A system for promoting drug products using the Web, comprising:
an administrator website;
a network of pharmacies that is driven to offer lower prices for drug products in response to a rebate structure that is based on reaching certain levels of market share at target drug product prices; and
the website listing the network of pharmacies to promote that the network of pharmacies offer lower pricing for drug products for members.

10. The system of claim 9, the administrator website having a webpage to register potential members meeting eligibility requirements.

11. The system of claim 9, wherein the rebate structure has built-in incentives to decrease the cost of drug products to members.

12. The system of claim 11, wherein the administrator website has links to the network of pharmacies.

13. The system of claim 12, wherein the administrator website has contact information for the network of pharmacies.

14. The system of claim 10, wherein the eligibility requirements include potential members who do not have insurance coverage.

15. The system of claim 10, wherein the eligibility requirements include potential members who do not have drug product insurance coverage.

16. The system of claim 10, wherein the eligibility requirements include potential members who have limited insurance coverage.

17. The system of claim 9, wherein the rebate structure provides increasingly greater rebates for greater market share at lower drug product prices.
